(19) United States
(12) Patent Application Publication
(10) Pub. No.: US 2011/0095504 A1
(43) Pub. Date: Apr. 28, 2011

(54) Mounting System for a Truck Fender

(75) Inventor: David A. Jones, West Middlesex, PA (US)

(73) Assignee: Jones Performance Products, Inc., West Middlesex, PA (US)

(21) Appl. No.: 12/910,460

(22) Filed: Oct. 22, 2010

Related U.S. Application Data
(60) Provisional application No. 61/254,679, filed on Oct. 24, 2009.

(51) Int. Cl. B60R 19/00; B60R 19/02; F16M 13/02

(52) U.S. Cl. 280/160; 293/102; 248/201

(57) ABSTRACT

An article for mounting a fender to a truck frame is described. The article permits the fender to swing up and away from the tire, so that the tire can be accessed without removal of the fender. The article includes first and second brackets mounted to the truck frame. The first bracket includes a hinge. The truck fender includes first and second sections. The hinge is mounted to the first section of the truck fender. The second section includes an armature that removably mounts to the second bracket. Unmounting the armature from the second bracket permits the truck fender to rotate about the hinge thereby exposing the tire.

### This application is a non-provisional application of U.S. patent Ser. No. 61/254,679, which is hereby incorporated by reference.

### FIELD OF THE INVENTION

The invention relates to an article for mounting a truck fender, particularly a rear fender.

### BACKGROUND OF THE INVENTION

Rear fenders are typically fixedly secured to a frame of a truck using a plurality of mechanical fasteners. Removal of the fender can be time-consuming, tedious, and dirty. The fasteners are often inconveniently located so that a technician must climb under the frame to remove the fasteners.

Because tires must occasionally be removed for maintenance or replacement, fender designs often permit removal of the tires without removal of the fender. Fenders that obstruct removal of the tire increase repair time and costs. A rear fender can be over 8 feet long and weigh more than 100 pounds. At least two technicians are required to manipulate a fender of this size and weight.

The inconvenience of fender removal can limit the scope of commercially viable fender designs. Such designs include both aesthetic and functional aspects. For example, aerodynamics favors covering at least a portion of the tire with a fender, but such designs are avoided for practical maintenance reasons.

### SUMMARY OF THE INVENTION

The present invention relates to an article for mounting a fender to a truck frame. The article permits the fender to swing up and away from the tire, so that the tire can be accessed without removal of the fender. The article can be operated by a single technician despite the length and weight of the fender. Advantageously, the article permits any convenient fender design that suits aesthetic or practical considerations. In embodiments, the fender can substantially cover the tire to reduce aerodynamic drag.

The article includes first and second brackets fixedly mounted to the truck frame. The first bracket includes a hinge. The truck fender includes first and second sections. The hinge is mounted to the first section of the truck fender. The second section includes an armature that removably mounts to the second bracket. Unmounting the armature from the second bracket permits the truck fender to rotate about the hinge thereby exposing the tire.

The brackets are typically mounted to the sections using mechanical fasteners. The armature can be mounted to the second bracket by at least one fastener. Conveniently, the second bracket can be located in a position that permits a technician to remove the fastener without undue strain.

Optionally, a support mounted to the truck frame supports a middle section of the fender. The support can include a rubber bumper.

### BRIEF DESCRIPTION OF THE DRAWINGS

FIG. 1 shows the article of the invention on a truck rear fender.

FIG. 2 shows, mounted to a truck frame, a first bracket with a hinge

FIG. 3 shows a second bracket mounted to a truck frame.

FIG. 4 shows a support between the first and second brackets.

FIG. 5 shows the support of FIG. 4 mounted to a truck frame.

FIG. 6 shows a first section of a truck fender mounted to the hinge of the first bracket.

FIG. 7 shows an armature mounted to the second bracket.

FIG. 8 shows the armature mounted to the second section of the truck fender.

### DETAILED DESCRIPTION OF THE INVENTION

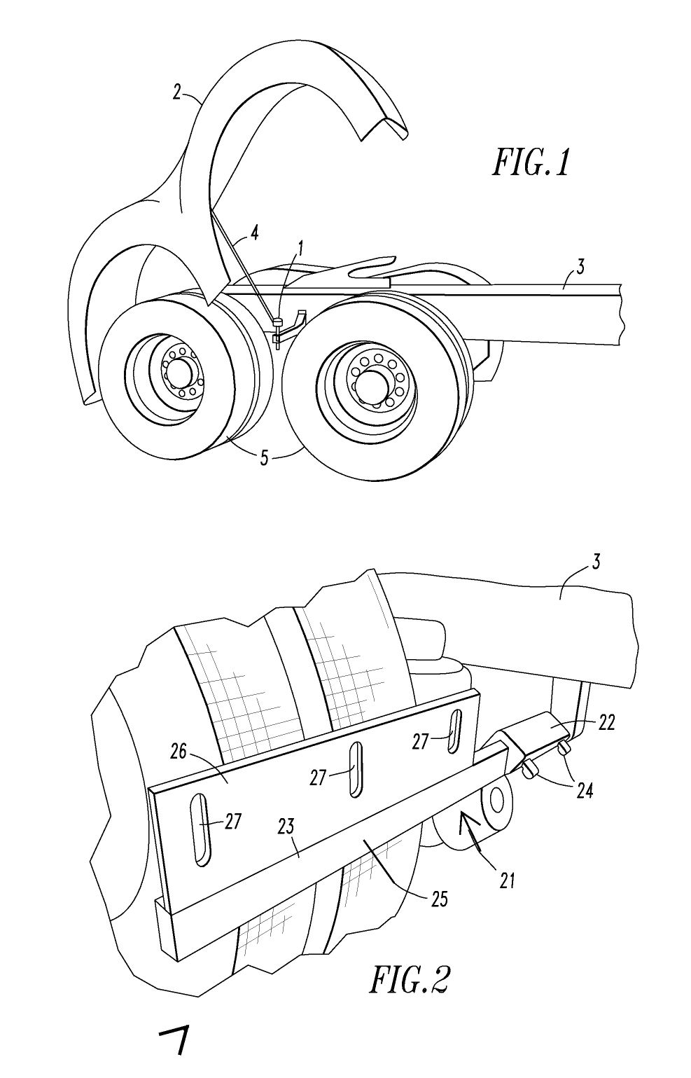

In normal operation, a truck rear fender extends around the rear tires of a truck in an unrotated position. The present invention permits rotation of the truck fender 2 about a hinge. FIG. 1 shows how the device 1 can be used to place the truck rear fender 2 in a rotated position. The fender 2 hinges in the rear of the truck frame 3 and is propped in place using a pole 4. Notably, all four rear tires 5 are fully accessible and can be removed or repaired without actually detaching the fender 2 from the frame 3.

FIG. 2 shows a first bracket 21 fixedly secured to the truck frame 3. The first bracket 21 includes a hinge 23. In this embodiment, the first bracket 21 includes a first portion 22 fixedly secured to the truck frame 3 and a second portion 25 secured to the first portion 22 with a plurality of mechanical fasteners 24. This facilitates installation of the fender (not shown) onto the truck frame 3. The hinge 23 can include a plate 26 for connecting to the fender. In the present embodiment, the plate 26 defines three mounting points 27 for mechanical fasteners. One skilled in the art would appreciate that the number and type of mount points can vary depending on the fender, in particular its size, weight and composition.

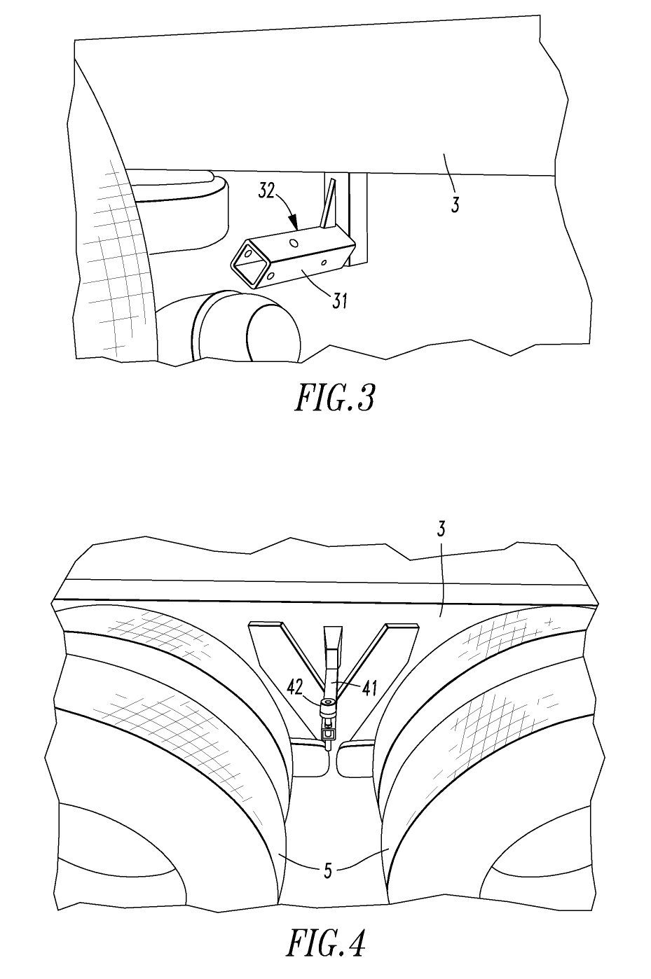

FIG. 3 shows a second bracket 31 fixedly secured to the truck frame 3. Conveniently, the second bracket 31 can include a polygonal shape. Such a shape can limit rotation of the fender and provide a flat connecting surface 32.

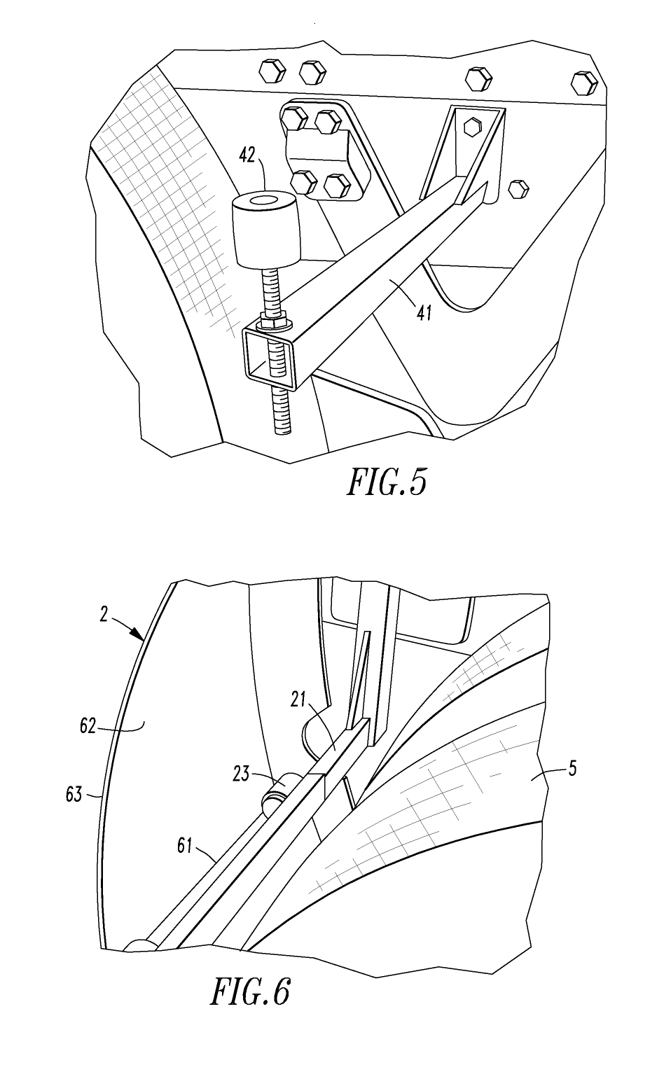

FIGS. 4 and 5 show a support 41 for the fender (not shown). The support 41 is useful for large fenders. In this embodiment, the support 41 is positioned between a pair of rear tires 5. The support 41 is securely mounted to the truck frame 3. The fender can rest on the support 41 when the truck fender is in an unrotated position. The support can be fastened to the fender, but the weight of the fender itself can be sufficient to maintain contact so that no fastener is required. The support can reduce flex and vibration in the fender. In embodiments, the support 41 can include a bumper 42. The bumper preferably comprises a vibration dampening material, such as rubber.

FIG. 6 shows the hinge 23 of the first bracket 21 connected to a first section 61 of the fender 2. The first bracket 21 and section 61 can be connected by any convenient fastener including, for example, adhesive and mechanical fasteners. In embodiments, a threaded fastener secures the fender 2 to the hinge 23. Conveniently, an underside of the fender 2 includes a first mounting surface 62. The mounting surface 62 can include an embedded nut so that the fastener is invisible from the top surface of the fender 63.

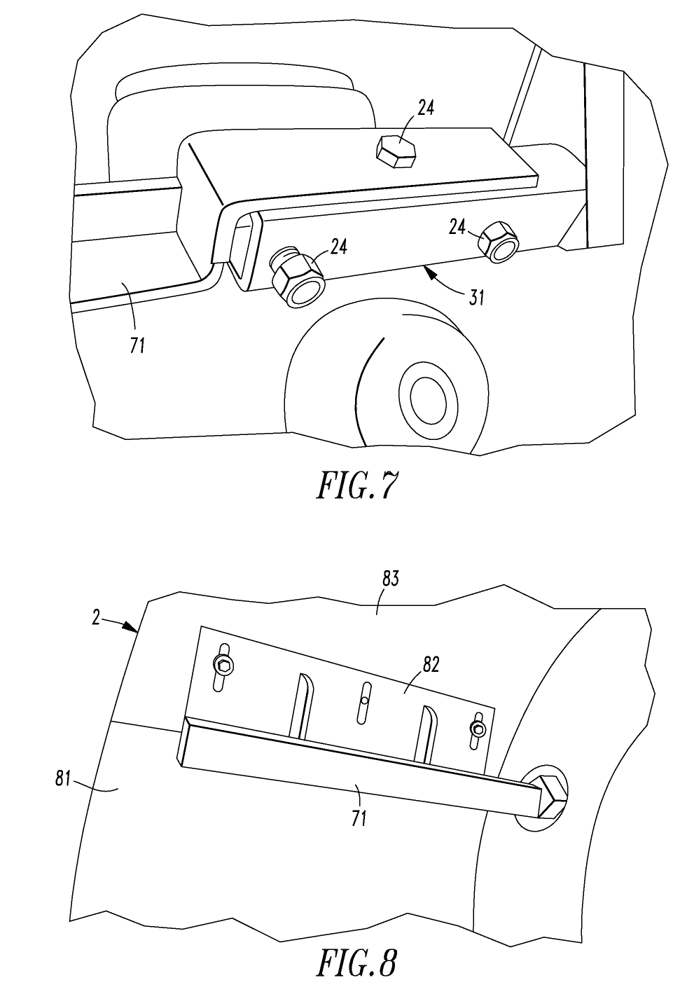

FIG. 7 shows an armature 71 removably mounted to the second bracket 31. In this embodiment, three mechanical fasteners 24 secure the armature 71 to the second bracket 31. One skilled in the art would appreciate that the type and number of fasteners can be varied. For example, one fastener could be sufficient to removably mount the armature 71 to the second bracket 31.

FIG. 8 shows the armature 71 attached to the underside of the fender 81. In this embodiment, the armature 71 includes a mounting plate 82 secured to a second mounting surface 83 of the fender 2. Fastening can be performed as with the first bracket and first section.

Conveniently, a fender for use with the present invention can comprise a shell and a liner separated by a gap. The shell forms an exterior surface facing away from a tire. The liner forms an underside of fender facing the tire. The gap separates the shell and the liner so that damage to the liner such as, for example, by a stone thrown by the tire, is not necessarily transmitted to or visible in the shell. Additionally, the gap can be used to conceal fasteners that would otherwise protrude through the shell. For example, the gap can include embedded nuts that accept bolts for the mounting of the fender to the brackets.

What is believed to be the best mode of the invention has been described above. However, it will be apparent to those skilled in the art that numerous variations of the type described could be made to the present invention without departing from the spirit of the invention. The scope of the present invention is defined by the broad general meaning of the terms in which the claims are expressed.

1. An article for mounting a fender to a truck frame comprises first and second brackets mounted to the truck frame, the first bracket includes a hinge mounted to a first section of the truck fender, the truck fender includes a second section comprising an armature capable of removably mounting to the second bracket, whereby unmounting the armature permits the truck fender to rotate about the hinge to a rotated position from an unrotated position.

2. The article of claim 1, wherein the article include a pole for propping the truck fender in place when the truck fender is in the rotated position.

3. The article of claim 1, wherein the first bracket includes a first portion fixedly secured to the truck frame and a second portion secured to the first portion with a plurality of mechanical fasteners.

4. The article of claim 1, wherein the hinge includes a plate for connecting to the fender.

5. The article of claim 4, wherein the plate defines a plurality of mounting points for mechanical fasteners.

6. The article of claim 1, wherein the second bracket includes a flat connecting surface.

7. The article of claim 1, wherein the second bracket includes a polygonal shape adapted to limit rotation of the fender.

8. The article of claim 1, wherein the article includes a support positioned between the first and second brackets, whereby the truck fender can rest on the support when in the unrotated position.

9. The article of claim 8, wherein the support includes a bumper contacting the truck fender in the unrotated position.

10. An article for mounting a fender to a truck frame comprising:
a. a truck fender comprising a top surface, an underside, a first section including a first mounting surface on the underside, and a second section including an armature; and
b. a hinge mount comprising first and second brackets mounted to the truck frame, the first bracket includes a hinge mounted to the first mounting surface, the armature removably mounted to the second bracket, whereby unmounting the armature permits the truck fender to rotate about the hinge.

11. The article of claim 10, wherein the armature is mounted to the second bracket using at least one mechanical fastener.

12. The article of claim 10, wherein the first mounting surface includes an embedded nut so that the mechanical fastener is invisible from the top surface of the truck fender.

13. The article of claim 10, wherein underside includes a second mounting surface, and the armature includes a mounting plate secured to the second mounting surface of the fender.

14. The article of claim 10, wherein the truck fender comprises a shell comprising the top surface and a liner comprising the underside, and the shell and the liner are separated by a gap.

15. The article of claim 14, wherein the gap conceals mechanical fasteners that would otherwise be visible on the top surface.

16. A device for securing a truck fender to a truck frame comprising:
a. a truck fender including a shell comprising a top surface, a liner separated by a gap from the shell and comprising an underside, the underside comprising a first section including a first mounting surface and a second section including an armature comprising a mounting plate; and
b. a hinge mount comprising first and second brackets mounted to the truck frame, the first bracket includes a hinge mounted to the first mounting surface, the mounting plate capable of removably mounting to the second bracket, whereby unmounting the mounting plate permits the truck fender to rotate about the hinge from an unrotated position to a rotated position.

17. The device of claim 16, wherein the truck fender is mounted to the hinge mount by a plurality of mechanical fasterners.

18. The device of claim 16, wherein the mechanical fasteners terminate in the gap between the shell and the liner, whereby the mechanical fasteners are not visible on the top surface.

19. The device of claim 16, wherein the device includes a support positioned between the first and second brackets, whereby the truck fender can rest on the support when in the unrotated position.

20. The device of claim 19, wherein the support includes a bumper contacting the truck fender in the unrotated position.
